(19) United States
(12) Patent Application Publication
(10) Pub. No.: US 2007/0235436 A1
(43) Pub. Date: Oct. 11, 2007

(54) Heating system

(76) Inventor: John Clay Purdy, Alberta (CA)

Correspondence Address: DIEDERIKS & WHITELAW, PLC, #301, 12471 Dillingham Square, Woodbridge, VA, 22192, US

(21) Appl. No.: 11/589,643

(22) Filed: Oct. 30, 2006

Related U.S. Application Data
(60) Provisional application No. 60/788,056, filed on Apr. 3, 2006.

(51) Int. Cl. F27D 11/00

(52) U.S. Cl. 219/385

(57) ABSTRACT

An improved heating system for providing a faster and more efficient method of cooking or heating the contents of a container such as cookware where the container or cookware is placed on a heating surface such as a burner or stove, which includes a skirt for surrounding the exterior of a container for defining a heat capture and insulating region between the skirt and the exterior of the container for trapping heat from the heating surface in the insulating region and for reducing heat transference from the exterior walls of the container to the atmosphere. In another embodiment, the present system includes a container having an integrated skirt for defining an insulating region between the skirt and the exterior of the container for trapping heat from the heating surface in the insulating region and for reducing heat transference from the exterior walls of the container to the atmosphere.

### CROSS REFERENCE TO RELATED APPLICATIONS

This application claims the benefit of priority of U.S. Provisional Application Ser. No. 60/788,056 filed Apr. 3, 2006, entitled “HEATING SYSTEM”.

### FIELD OF THE INVENTION

The present invention relates generally to a system for improving the heating of containers such as cookware which are placed on a heating surface such as a heating element on a stove for heating or cooking the contents of the container which may be food or liquid or some other substance. More particularly, the present invention relates to a skirt for surrounding the exterior of a container for defining an insulating region between the skirt and the container which traps heat from the heating surface in the insulating region and insulates the container from its environment.

### BACKGROUND OF THE INVENTION

Conventional heating systems including containers such as cookware for use on a stove top element have various problems associated with them. One such problem is that cooking or heating on a conventional stove using cookware can take a long time which is undesirable for today's fast-paced society. This explains, in part, the success of faster cooking means such as the microwave oven. However, the use of a microwave oven is undesirable for cooking particular foods as microwave ovens are not particularly well-suited for cooking some foods as their primary use is for heating foods.

In other circumstances, an alternative heating system such as a microwave oven is not available, in which case the user requires a portable system.

Another difficulty with conventional heating systems is that they require large amounts of energy to provide the necessary heat to the container for properly heating or cooking the contents of the container. This is particularly undesirable in societies where energy is becoming a scarce resource which has caused energy prices to rise making it desirable for consumers to minimize the energy used in heating systems. A system having improved thermal performance is therefore desirable.

Accordingly, there is a need for a faster and more efficient method of heating or cooking food or liquids in a container which is placed on a heating surface where the use of a microwave oven is undesirable or not available and where the user seeks to minimize the amount of energy required.

### SUMMARY OF THE INVENTION

An object of the present invention is to provide a faster and more efficient method of cooking or heating the contents of a container such as cookware where the container or cookware is placed on a heating surface.

The present system includes a skirt for surrounding the exterior of a container for defining an insulating region between the skirt and the exterior of the container for trapping heat from the heating surface in the insulating region and for reducing heat transference from the exterior walls of the container to the atmosphere.

In a further embodiment, the present system includes a skirt integrated with the container (such as a pot) for defining a heat capture and insulating region between the skirt and the exterior of the container for trapping heat from the heating surface in the insulating region and for reducing heat transference from the exterior walls of the container to the atmosphere.

### BRIEF DESCRIPTION OF THE DRAWINGS

The invention is described by reference to the accompanying drawings wherein:

FIG. 1 is a perspective view of an improved heating system in accordance with the present invention;

FIG. 2 is a cross-sectional side view of an improved heating system in accordance with the present invention;

FIG. 3 is a cross-sectional side view of a skirt in accordance with the present invention;

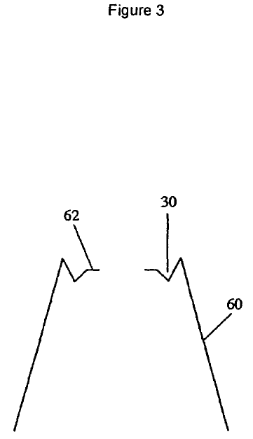

FIG. 4 is a front view in accordance with the present invention;

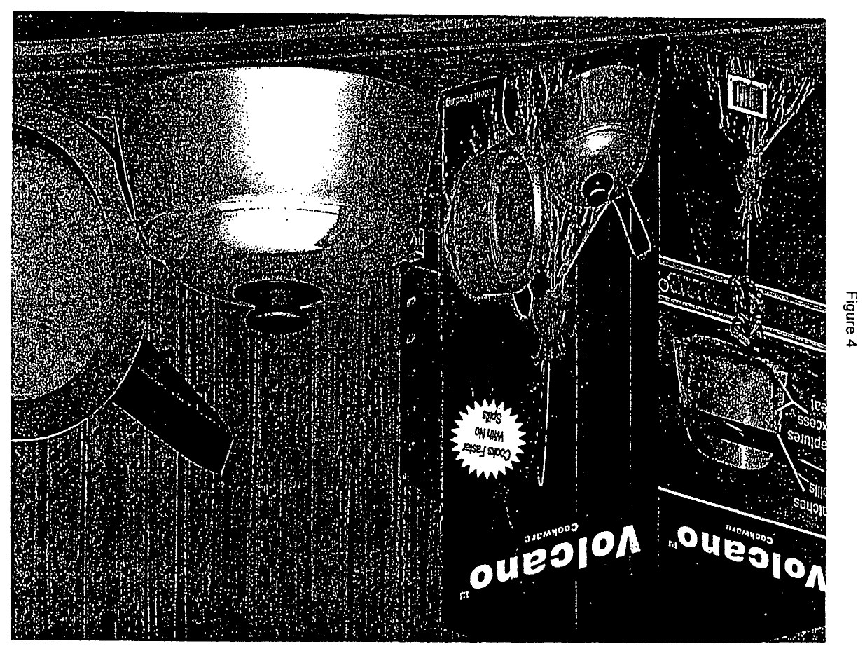

FIG. 5 is a cross-sectional view in accordance with the present invention;

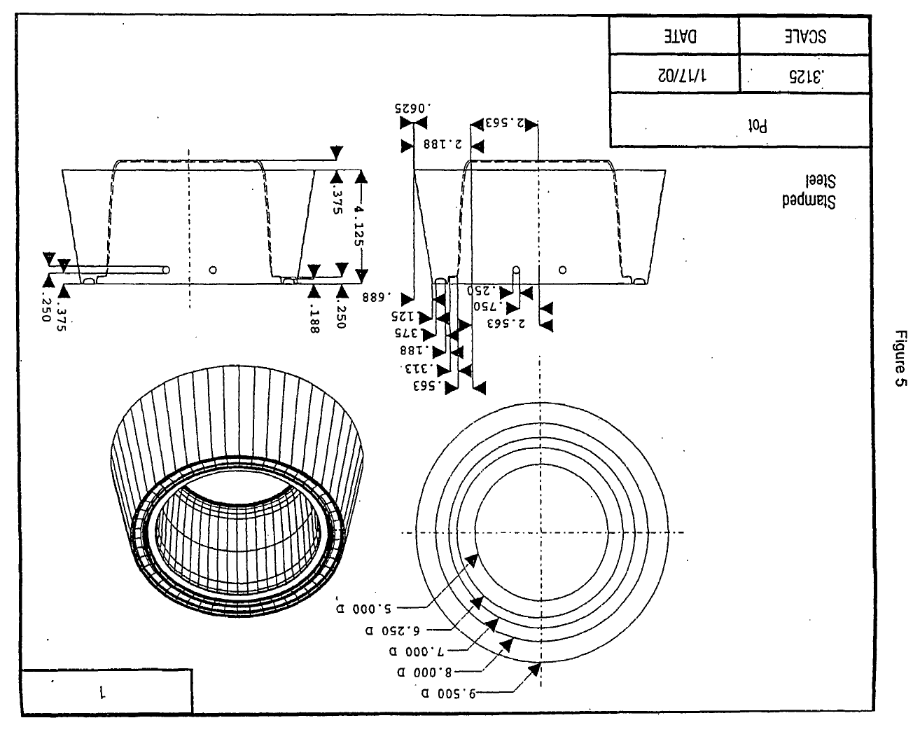

FIG. 6 is a front/side view in accordance with the present invention;

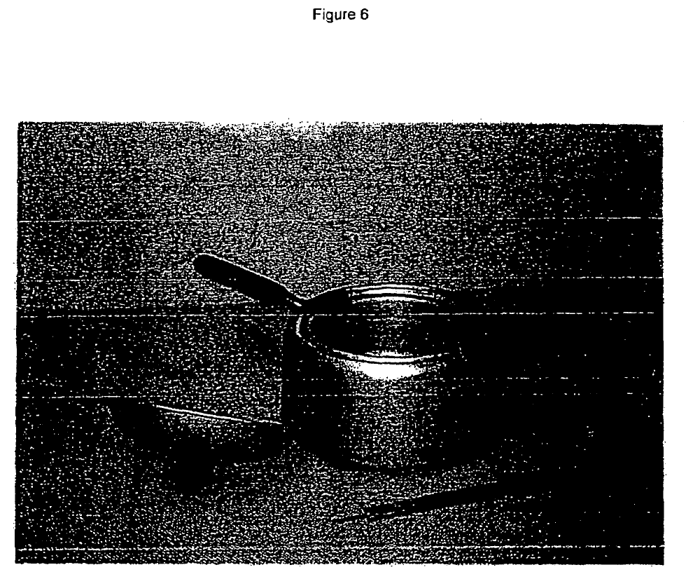

FIG. 7 is a inverted view in accordance with the present invention;

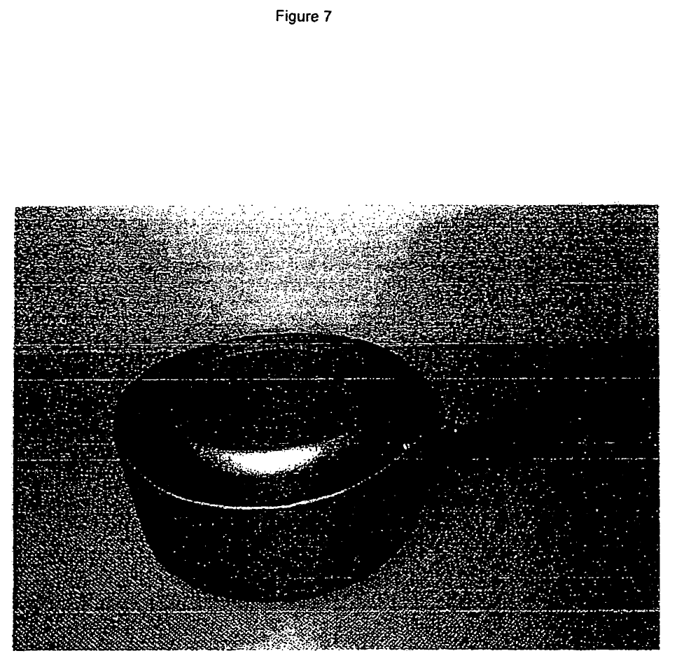

FIG. 8 is a front/side view in accordance with the present invention; and

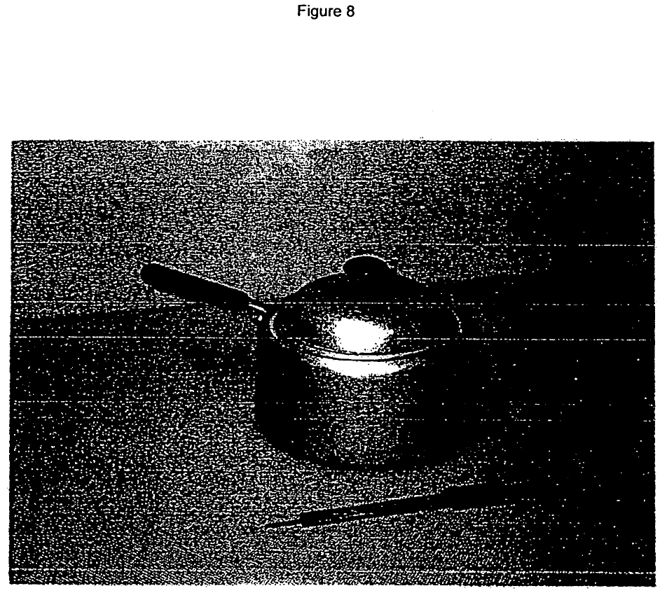

FIG. 9 is a front/side view in accordance with the present invention.

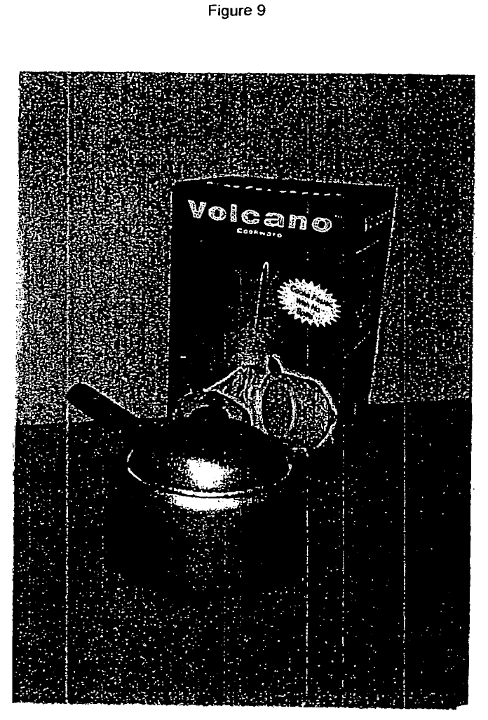

### DETAILED DESCRIPTION OF THE INVENTION

With reference to the figures, an improved heating system 100 is described. The improved heating system 100 generally includes a skirt 60 for operative placement around a container 10. Once skirt 60 is placed on container 10 such that skirt 60 is surrounding container 10, an insulating region 40 is defined as the volume between container 10 and skirt 60.

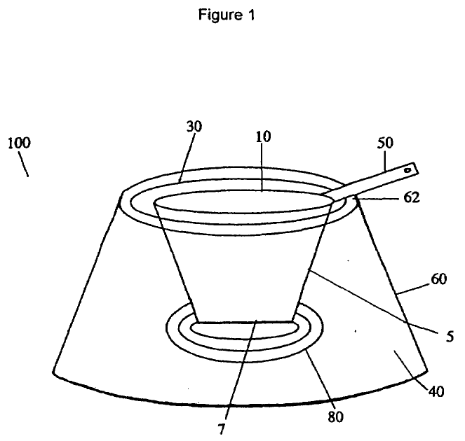

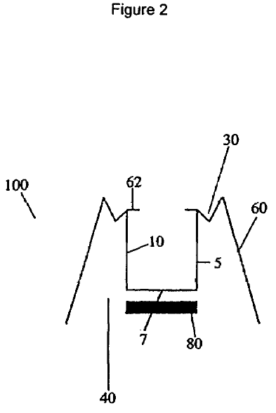

In general operation, a container 10 such as cookware or a cooking pot is placed on a heating surface 80 such as the heating elements on a conventional stove for heating or cooking the contents of that container 10 which may be food, liquids or other matter. Skirt 60 is placed around container 10 and lip 62 of the skirt 60 is placed on the top of the exterior wall 5 of container 10 such that skirt 60 surrounds the exterior wall 5 thereby defining an insulating region between skirt 60 and container 10 as shown in FIGS. 1 and 2. When the heating surface 80 is heated, the contents of container 10 are heated as base 7 of container 10 starts to increase in temperature. This will be well known by a worker skilled in the art. The object of this improved heating system having improved thermal performance is thereby achieved by the placement of the skirt 60. That is, skirt 60 traps heat emanating from heating surface 80 which would not otherwise be used or captured to increase the temperature of base 7 in the insulating region 40. In a conventional heating system with no skirt 60, such heat would be lost to the atmosphere and therefore would normally be wasted.

Skirt 60 also improves the thermal performance of container 10 by reducing heat transference from the exterior walls of the container to the atmosphere. That is, as the temperature surrounding the exterior wall 5 will be higher due to the heat captured from the heating surface 80 in the insulating region 40 than a conventional system, container 10 will experience less heat loss thereby improving the performance of the overall heating system. Region 40 forms a “dead air” insulating space surrounding the heated container, and reduces cooking by convection or conduction from the container to its environment.

Another advantage of the present system which is realized through the use of skirt 60 is that once the contents of the container 10 are cooked or heated, skirt 60, by trapping heat in insulating region 40, ensures that the contents of container 10 will stay warmer longer which is convenient for serving the contents and which also reduces or eliminates completely the need for reheating the contents before serving.

In a more specific embodiment, as shown in the figures, the present system may include a channel 30 which is defined at the top of skirt 60 for capturing and containing the contents of container 10 when such contents run or boil over the edge of container 10. This embodiment is particularly useful for the present system as the improved thermal performance of the system will initially result in users of the system underestimating the heating capacity of the present system as such users will initially be more accustomed to less effective conventional systems. Skirt 60 may include a plurality of channels (not shown) for capturing and storing a maximum of spillover contents.

Skirt 60 may be used with various containers which are heated on a heating surface. In one embodiment, skirt 60 may define an insulating region around cookware such as a cooking pot which is placed on the heating element of a conventional stove. In another embodiment, skirt 60 may surround a cooking pot designed for outdoor use which is heated by a campfire, a camp stove or a bar-b-que. In still another embodiment, skirt 60 may insulate the area around a coffee cup which is placed on a heating pad.

In one embodiment, a worker skilled in the art will appreciate that skirt 60 can be manufactured in a size suitable for surrounding most containers used for heating or cooking contents thereby allowing skirt 60 to be used with existing containers. A worker skilled in the art will further appreciate that a different skirt 60 may be manufactured for use with various suitable containers such as cookware, outdoor cookware and coffee cups.

A worker skilled in the art will appreciate that skirt 60 may be comprised of various materials but will be especially effective if skirt 60 is comprised of thermal insulating material for trapping the maximum amount of heat in insulating region 40. Additionally, skirt 40 may be made with reflective inner surface to better contain radiated heat from container 10.

In an alternate embodiment, a worker skilled in the art will appreciate that container 10 could be manufactured to include skirt 60 thereby removing the necessity to separately store skirt 60. That is, the present system may include a container 10 having a skirt 60 for creating an insulating region 40 surrounding the exterior wall 5 of container 10 for trapping additional heat emanating from heating surface 80 and for reducing the transference of heat from container 10 to the atmosphere. A worker skilled in the art will appreciate that the various embodiments of skirt 60 described above will also be suitable for this embodiment.

The embodiments of the present system described above are intended to be examples only. Alterations, modifications and variations may be effected to the particular embodiments by those of skill and the art without departing from the scope of the invention, which is defined solely by the claims appended hereto.

What is claimed is:

1. An improved heating system comprising a skirt for operatively surrounding a container and for defining an insulating region between an exterior wall of the container and interior walls of the skirt for improving the thermal performance of the container being heated.

2. An improved heating system as in claim 1 wherein the skirt also defines a channel for capturing a contents of the container which spills out of the container.

3. An improved heating system as in claim 1 wherein the container is a conventional cooking pot for use on an element on a stove.

4. An improved heating system as in claim 1 wherein the container is an outdoor cooking pot for use on a campfire or barbeque.

5. An improved heating system as in claim 1 wherein the skirt is composed of a thermally insulating material.

6. An improved heating system as in claim 1 wherein the skirt has a reflective inner surface.

7. An improved heating system comprising a cooking pot, the cooking pot including a skirt for defining an insulating region between exterior walls of the cooking pot and interior walls of the skirt for improving the thermal performance of the cooking pot.

8. An improved heating system as in claim 7 wherein the skirt also defines an upper channel for capturing a contents of the container which spills out of the container.

9. An improved heating system as in claim 7 wherein the container is a conventional cooking pot for use on an element on a stove.

10. An improved heating system as in claim 7 wherein the container is an outdoor cooking pot for use on a campfire or barbeque.

11. An improved heating system as in claim 7 wherein the skirt is composed of a thermally insulating material.

12. An improved heating system as in claim 7 wherein the skirt has a reflective inner surface.
